(19) United States
(12) Patent Application Publication
(10) Pub. No.: US 2019/0253811 A1
(43) Pub. Date: Aug. 15, 2019

(54) INTERACTIVE HEARING AID ERROR DETECTION

(71) Applicant: EarLens Corporation, Menlo Park, CA (US)

(72) Inventors: Takahiro UNNO, Foster City, CA (US); Lakshman RATHNAM, Mountain View, CA (US); Kulbir SANDHU, Fremont, CA (US); Bryan FLAHERTY, Mountain View, CA (US); Morteza KHALEGHIMEYBODI, Bellevue, WA (US)

(21) Appl. No.: 16/396,117

(22) Filed: Apr. 26, 2019

Related U.S. Application Data
(63) Continuation of application No. PCT/US2017/058086, filed on Oct. 24, 2017.
(60) Provisional application No. 62/414,588, filed on Oct. 28, 2016.

(51) Int. Cl. H04R 25/00

(52) U.S. Cl. CPC H04R 25/30; H04R 25/40; H04R 25/02; H04R 25/70; H04R 25/604

(57) ABSTRACT

The present invention is adapted to assist in optimizing the performance of a hearing aid by detecting conditions which result in sub-optimal performance and assisting a user or health care professional to correct those conditions. The present invention is adapted to optimize the performance of a hearing aid by generating a reference signal which, when broadcast, creates a feedback signal. The feedback signal is then measured, or its characteristics identified, to determine whether the hearing aid system is optimized and, if not, what components or characteristics are not optimized and how to optimize the hearing aid system performance or that of its components.

### CROSS-REFERENCE

This application is a continuation of PCT Application No. PCT/US2017/058086, filed Oct. 24, 2017; which claims the benefit of U.S. Provisional Application No. 62/414,588, filed Oct. 28, 2016; which are incorporated herein by reference in their entirety.

### BACKGROUND OF THE INVENTION

### Field of the Invention

The present disclosure is related to hearing aids, hearing aid systems, and control methods therefor.

### Technical Background

In hearing aids where the position of the in-canal, or “ear tip”, portion of the hearing aid has an impact on the overall performance of the hearing aid, hearing-aid users typically position the in-canal, or “ear tip”, portion of the hearing aid in their ear canal using subjective cues. The ear tip may be positioned by, for example, finding a “sweet spot” where the sound from the hearing aid is most intelligible. Since this positioning depends on user's subjective impression of the sound quality, the position chosen may not be optimal and/or may change from insertion to insertion. Sub-optimal ear tip positioning may result in insufficient sound volume, patient discomfort, and/or increased feedback. In hearing aids that use optical signals to transmit sound to a device positioned on the user's tympanic membrane, sub-optimal ear tip positioning may result in sub-optimal optical coupling.

Hearing aid users also encounter problems with ear tip positioning because ear tips may change shape (e.g., as a result of wear or fatigue) over time, resulting in a sub-optimal fit and/or a tendency to migrate. Users may not notice these changes and may continue to use the worn/fatigued ear tip, compromising the performance of the hearing aid. Worn or fatigued ear tips may cause the same types of audio problems as the sub-optimal ear tip placement discussed above.

In a light driven hearing aid system, the alignment between transmitter and receiver depends, at least in part, on how well an ear tip fits in the user's ear and the position of the ear tip in the user's ear canal. In light driven hearing-aids, users typically place the ear tip into their ear using subjective cues (e.g., they find a “sweet spot” by listening to the quality of the sound and adjusting the Ear Tip accordingly). Since this method of aligning the transmitter and receiver depends on the sound quality as perceived by the user, the resulting ear tip location may not be optimal. Sub-optimal ear tip location may cause, for example, insufficient sound volume, sub-optimal optical coupling, patient discomfort, and/or increased feedback.

In certain types of hearing aids, such as contact hearing aids, sub-optimal performance may also be caused by components of the hearing aid or hearing aid system moving or degrading over time. For example, in a light driven hearing aid, the component which sits on the tympanic membrane may migrate from its original position over time, resulting in degraded system performance. For example, in a contact hearing aid which utilizes a tympanic lens, the migration of the tympanic lens may result in misalignment between the tympanic lens and the tympanic membrane, degrading system performance.

### SUMMARY OF THE INVENTION

The present invention is adapted to assist in optimizing the performance of a hearing aid by detecting conditions which result in sub-optimal performance and assisting a user or health care professional to correct those conditions. In one embodiment, the present invention is adapted to optimize the performance of a hearing aid by generating a reference signal which, when broadcast, creates a feedback signal. The feedback signal may then be measured, or its characteristics identified, to determine whether the hearing aid system is optimized and, if not, what components or characteristics are not optimized and how to optimize the hearing aid system performance or that of its components.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The foregoing and other objects, features and advantages of embodiments of the present inventive concepts will be apparent from the more particular description of preferred embodiments, as illustrated in the accompanying drawings in which like reference characters refer to the same or like elements. The drawings are not necessarily to scale; emphasis instead being placed upon illustrating the principles of the preferred embodiments.

FIG. 1 is a cutaway view of an ear canal showing a contact hearing system for use in a method according to the present invention wherein at least a portion of the contact hearing system is positioned in the ear canal.

FIG. 2 is a cutaway view of an ear canal showing an ear tip and contact hearing device for use in a method according to the present invention, wherein the ear tip and contact hearing device are positioned in the ear canal.

FIG. 3 is a block diagram of a contact hearing system for use in a method according to the present invention.

FIG. 4 is a block diagram of a contact hearing system for use in a method according to the present invention.

FIG. 5 is an illustration of a contact hearing device according to one embodiment of the present invention.

FIG. 6 is a block diagram of an acoustic hearing system according to one embodiment of the present invention.

FIG. 7 is a diagram of a linear chirp waveform which may be used as a reference signal in embodiments of the present invention.

### DETAILED DESCRIPTION OF THE INVENTION

### Definitions

Audio Processor (BTE)—A system for receiving and processing audio signals. In embodiments of the invention, audio processors may include one or more microphones adapted to receive audio which reaches the user's ear. In embodiments of the invention, the audio processor may include one or more components for processing the received sound. In embodiments of the invention, the audio processor may include digital signal processing electronics and software which are adapted to process the received sound. In embodiments of the invention, processing of the received sound may include amplification of the received sound.

Contact Hearing System—A system including a contact hearing device, an ear tip and an audio processor. In embodiments of the invention, contact hearing systems may also include an external communication device. An example of such system is the Earlens light driven hearing-aid, available from the Earlens Corporation, which transmits audio signal by laser to a contact hearing device (e.g., a tympanic membrane transducer or “TMT”) wherein the contact hearing device is placed on an ear drum.

Contact Hearing Device (Tympanic Contact Actuator (TCA)/Tympanic Membrane Transducer (“TMT”))—a tiny actuator connected to a customized ring-shaped support platform that floats on the ear canal around the eardrum, and resides in the ear much like a contact lens resides on the surface of the eye, where the actuator directly vibrates the eardrum which causes energy to be transmitted through the middle and inner ears to stimulate the brain and produce the perception of sound. In embodiments of the invention, the contact hearing device may comprise a photodetector, a microactuator connected to the photodetector, and a support structure supporting the photodetector and microactuator. In embodiments of the device, the photodetector may be replaced with an inductive coil or an RF antenna.

Ear Tip (Light Tip)—A structure designed to be placed into and reside in the ear canal of a user, where the structure is adapted to receive signals intended to be transmitted to the user's tympanic membrane or to a device positioned on or near the user's tympanic membrane (such as, for example, a contact hearing device). In one embodiment of the invention, the signals may be transmitted by light, using, for example, a laser positioned in the light tip. In one embodiment of the invention, the signals may be transmitted using radio frequency, using, for example, an antenna connected to the Ear Tip. In one embodiment of the invention, the signal may be transmitted using inductive coupling, using, for example, a coil connected to the Ear Tip.

External Communication and Control Device (Contact Hearing Aid)—a device or other interface (e.g., Cell Phone, Smart Phone, Remote Control Unit, etc.) which communicates with the Contact Hearing System, either through a wired or wireless connection (e.g., through the Cloud), to allow a subject, a patient, a medical professional, an automatic control system, or other user to control, set the parameters of, and/or receive operating and/or other information for the Contact Hearing System.

Light Driven Hearing Aid System—a contact hearing system wherein signals are transmitted from the ear tip to the contact hearing device using light. In a light driven hearing system, light (e.g., laser light) may be used to transmit information, power or both information and power to the contact hearing device.

Light Tip—an ear tip adapted for use in a light driven hearing aid system. In embodiments of the invention, a light tip may comprise a laser.

### DESCRIPTION

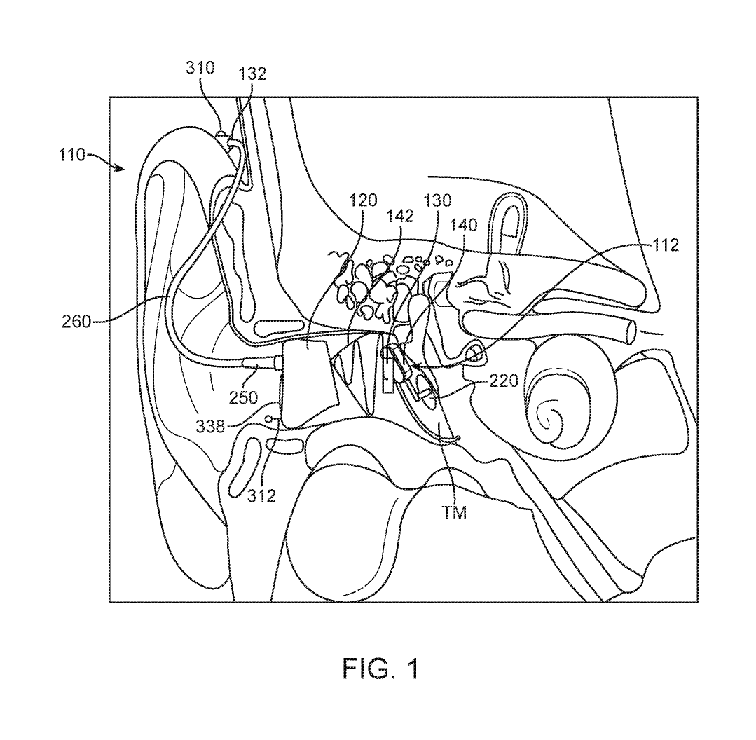

FIG. 1 is a cutaway view of an ear canal showing a contact hearing system 110 for use in a method according to the present invention, wherein the contact hearing system 110 is positioned in the ear canal. In embodiments of the invention, contact hearing system 110 may comprise a contact hearing system using light to transmit information and/or power from the ear tip to the contact hearing device. In embodiments of the invention, contact hearing system 110 may comprise a contact hearing system using inductive coupling to transmit information and/or power from ear tip 120 to contact hearing device 112. In FIG. 1, contact hearing system 110 includes Audio processor 132, which audio processor may include at least one external microphone 310. Audio processor 132 may be connected to an ear tip 120 by cable 260, which is adapted to transmit signals from audio processor 132 to ear tip 120. Taper tube 250 may be used to support cable 260 at ear tip 120. Ear tip 120 may further include canal microphone 312 and acoustic vent 338. Ear tip 120 may be a light tip which radiates light pulses 142 in response to signals from audio processor 132. Light or other signals radiated by ear tip 120 may be received by contact hearing device 112, which may comprise photodetector 130, microactuator 140, and umbo platform 220.

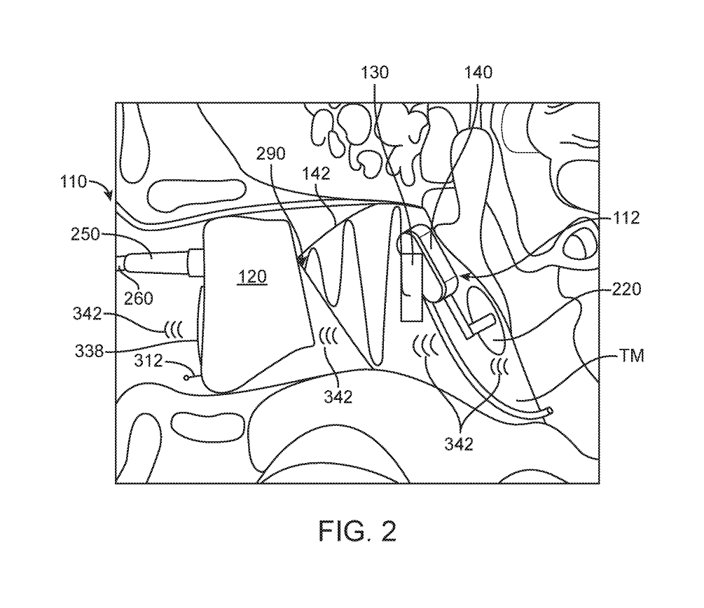

FIG. 2 is a cutaway view of an ear canal showing an ear tip 120 and contact hearing device 112 for use in a method according to the present invention wherein the ear tip 120 and contact hearing device 112 are positioned in the ear canal. In FIG. 2, contact hearing system 110 includes an audio processor (not shown). The audio processor may be connected to an ear tip 120 by cable 260, which is adapted to transmit signals from audio processor 132 to ear tip 120. Taper tube 250 may be used to support cable 260 at ear tip 120. Ear tip 120 may further include canal microphone 312 and acoustic vent 338. Ear tip 120 may be a light tip which includes light source 290 which radiates light pulses 142 in response to signals from audio processor 132. In embodiments of the invention, light source 290 may be a laser. Light or other signals radiated by ear tip 120 may be received by contact hearing device 112, which may comprise photodetector 130, microactuator 140, and umbo platform 220. In embodiments of the invention, signals transmitted by light tip 120 may be received by photodetector 130. The output of photodetector 130 may be used to power microactuator 140, causing umbo pad 220 to move. When contact hearing device 112 is positioned in the ear canal such that umbo pad 220 is in contact with tympanic membrane TM, the movement of umbo pad 220 causes tympanic membrane TM to move, resulting in the generation of an acoustic feedback signal 342.

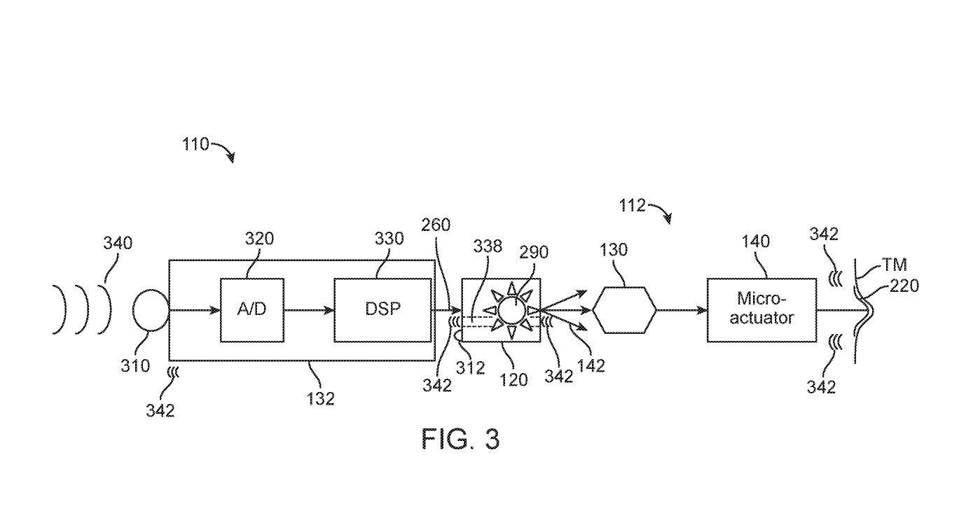

FIG. 3 is a block diagram of a contact hearing system 110 for use in a method according to the present invention. In embodiments of the invention, contact hearing system 110 is positioned in the ear canal of a user. In FIG. 3, ambient sound 340 may be received by external microphone 310 of audio processor 132, which then processes the received sound by passing it through processing circuitry, which may include analog to digital converter 320 and digital signal processor 330. The output of audio processor 132 may be transmitted to an ear tip 120 by cable 260. Signals transmitted to ear tip 120 may then be transmitted to contact hearing device 112 by, for example, causing light source 290 to radiate light pulses 142. In embodiments of the invention, contact hearing device 112 may include photodetector 130, microactuator 140, and umbo lens 220. Light pulses 142 received by photodetector 130 may be transmitted to microactuator 140, moving umbo lens 220, and generating feedback signal 342. Feedback signal 342 may be detected by canal microphone 312 and/or external microphone 310.

In embodiments of the invention, the signal transmitted to ear tip 120 may be a signal representative of the received audio signal which may then be transmitted to contact hearing device 112. In embodiments of the invention, the signal transmitted to ear tip 120 may be a control signal configured to cause the vibration of the tympanic membrane to generate a feedback signal 342. Feedback signal 342 may then travel down the ear canal to ear tip 120 and through ear tip 120 by, for example, passing through an acoustic vent 338. After being generated, feedback signal 342 may be detected by one or more microphones associated with contact hearing system 110. Feedback signal 342 may be detected by one or more of canal microphone 312 or external microphone 310.

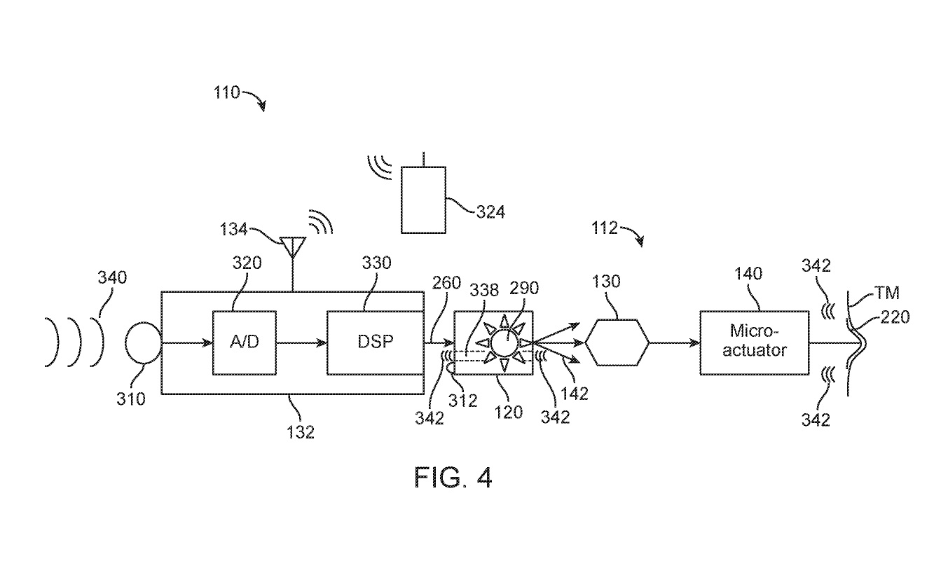

FIG. 4 is a block diagram of the contact hearing system 110 illustrated in FIG. 3 for use in a method according to the present invention wherein the contact hearing system 110 may be positioned in the ear canal of a user. In embodiments of the invention, contact hearing system 110 may include one or more external communication and control devices 324. In embodiments of the invention, audio processor 132 may communicate with external communication and control devices 324 by, for example, using audio processor antenna 134.

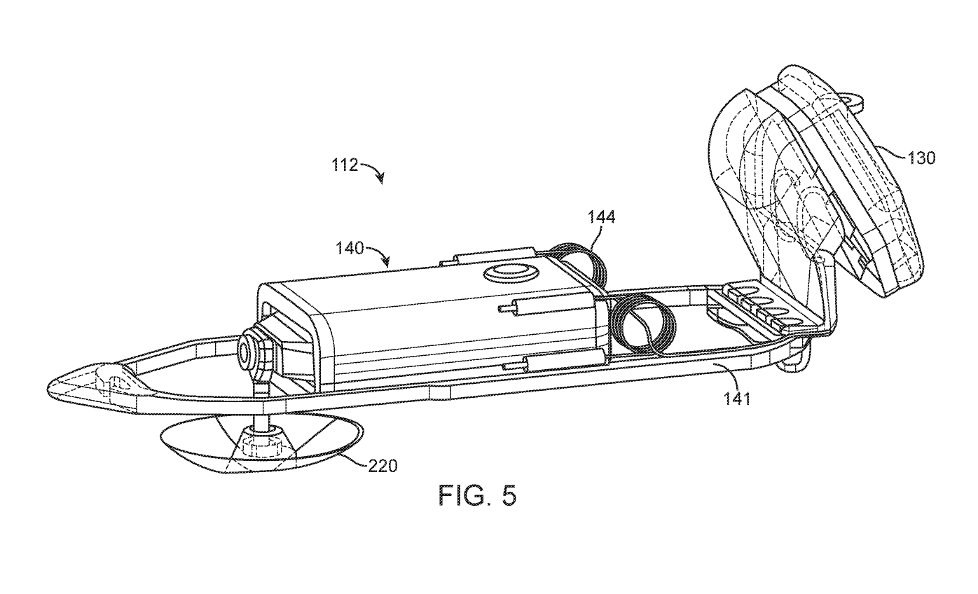

FIG. 5 is an illustration of a contact hearing device 112 according to one embodiment of the present invention. The contact hearing device 112 illustrated in FIG. 5 includes a photodetector 130, a microactuator 140, an umbo lens 220, a support structure 141, and springs 144. In the embodiment illustrated in FIG. 5, microactuator 140 is connected to support structure 141 by springs 144. In embodiments of the invention, contact hearing device 112 may further include a sulcus platform (not shown) connected to support structure 141 and adapted to assist in positioning contact hearing device 112 in the ear canal of a user.

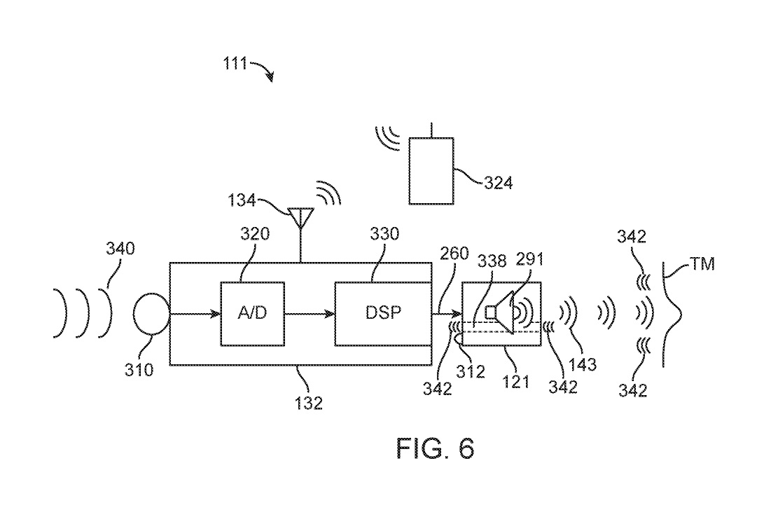

FIG. 6 is a block diagram of an acoustic hearing system 111 according to one embodiment of the present invention wherein the acoustic hearing system 111 is positioned in the ear canal of a user. In FIG. 6, ambient sound 340 may be received by external microphone 310 of audio processor 132, which then processes the received sound by passing it through processing circuitry, which may include analog to digital converter 320 and digital signal processor 330. The output of audio processor 132 may be transmitted to a receiver 121 by cable 260. Signals transmitted to receiver 121 may then be transmitted to tympanic membrane TM by, for example, generating acoustic signal 143 and resulting in the movement of tympanic membrane TM and generating feedback signal 342. In embodiments of the invention, the signal transmitted to receiver 121 may be a signal representative of the received audio signal 340. In embodiments of the invention, receiver 121 may include speaker 291. In embodiments of the invention, the signal transmitted to receiver 121 may be a control signal configured to cause the vibration of tympanic membrane TM to generate a feedback signal 342. Feedback signal 342 may travel down the ear canal to receiver 121 and through receiver 121 by, for example, passing through acoustic vent 338. After being generated, feedback signal 342 may be detected by one or more microphones associated with acoustic hearing system 111. Feedback signal 342 may be detected by one or more of canal microphone 312 or external microphone 310. In embodiments of the invention, contact hearing system 110 may include one or more external communication and control devices 324. In embodiments of the invention, audio processor 132 may communicate with external communication and control devices 324 by, for example, using audio processor antenna 134.

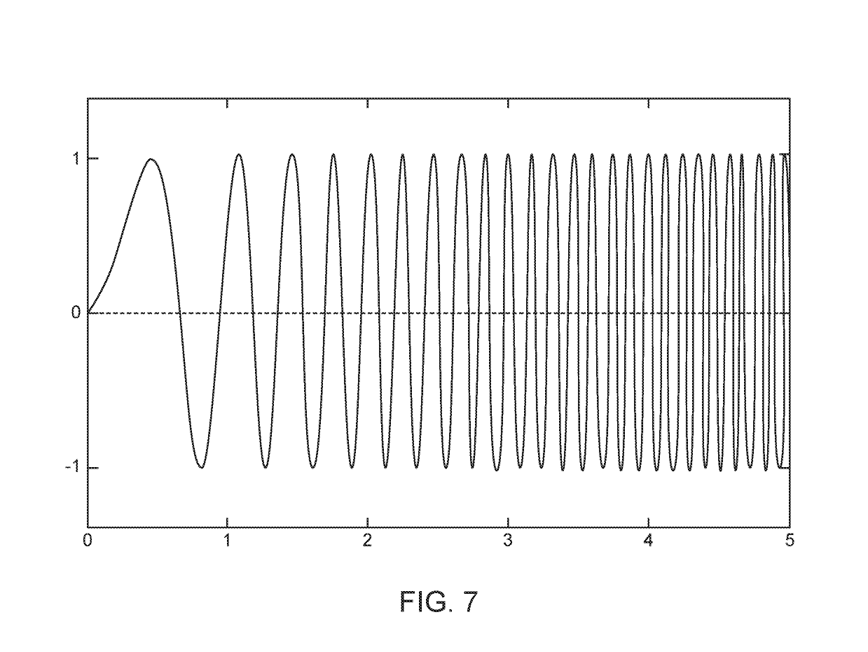

FIG. 7 is a diagram of a linear chirp waveform which may be used as a reference signal in embodiments of the present invention. A chirp is a sinusoidal wave that increases in frequency linearly over time. In embodiments of the invention, an optical reference signal may be transmitted to a contact hearing device positioned on the tympanic membrane which contact hearing device 112 generates a mechanical vibration having the waveform illustrated in FIG. 7, causing the tympanic membrane to vibrate and producing a feedback signal 342 which may be detected by external microphone 310 and/or canal microphone 312. In embodiments of the invention, an acoustic reference signal having the waveform illustrated in FIG. 7 may be transmitted by receiver 121 causing tympanic membrane TM to vibrate and generating a feedback signal 342 which may be detected by external microphone 310 and/or canal microphone 312.

### Operation

In one embodiment, the present invention is adapted to optimize the performance by generating a reference signal, which in turn, results in the generation of a feedback signal. The feedback signal may then be measured and used to provide the user with an indication of any errors in the system and how to correct those errors. In embodiments of the invention, detectable errors may include: a miss-positioned ear tip; a miss-positioned contact hearing device; lack of alignment between an ear tip and a contact hearing device; a clouded or obstructed photodetector on a contact hearing device; cerumen build up in the user's ear canal; and/or an occluded vent hole in an ear tip.

In one embodiment of the invention, the error may be sub-optimal ear tip positioning, which may be detected by measuring the feedback signal and corrected by adjusting the ear tip position until the feedback signal indicates that the ear tip is properly positioned. The present invention enables a hearing aid user to interactively locate an optimal ear tip position by producing a control signal and measuring a resulting feedback level. The measured feedback level may then be used to optimize the position of the ear tip.

In one embodiment, the present invention is adapted to measure the level of ear-tip wear and/or fatigue using a control signal to generate feedback and using the measured feedback to determine the level of ear tip wear and/or fatigue and provide the user with an alert to warn the user when the level of detected wear and/or fatigue reaches a predetermined point.

In one embodiment, the present invention is adapted to measure the displacement of a contact hearing device from its optimal position on a tympanic membrane. In the event the contact hearing device is properly placed, the feedback signal resulting from transmission of the reference signal will not change from its optimal value. In the event that the contact hearing device has moved from its optimal position, the feedback signal will differ from its optimal value. In embodiments of the invention, characteristics of the feedback signal (e.g. amplitude, phase or frequency) may be used to identify the amount of displacement.

The present invention may utilize a reference signal (e.g., a controlled signal stimulation) transmitted by an ear tip to generate a feedback signal. The present invention may utilize cell phone graphics and/or sound alerts to indicate errors, suboptimal operation or defective components. The present invention may utilize cell phone graphics and/or sound alerts to indicate that the user's hearing aid system is operating properly, such as, for example, that an ear tip is properly aligned or a contact hearing device is properly positioned.

In embodiments of the invention, the reference signal may be, for example: a single frequency, a chirp, white noise, an impulse function, a square wave function or a frequency scan. In embodiments of the invention, the chirp and/or frequency scan may contain frequencies between approximately 100 Hz and 10 KHz.

In embodiments of the invention, the hearing aid system may be set up and optimized prior to the transmission of an initial reference signal. Once the system is set up and optimized, the initial reference signal may be transmitted and the resulting feedback signal measured. This optimized feedback signal may then be used as a benchmark against which later feedback signals are measured. Thereafter, when the initial reference signal is retransmitted, the resulting feedback signal may be compared to the benchmark feedback signal to determine whether there has been any change in the system and, if there has been a change, the source of the change. In certain circumstances, the source of the change may be, for example: a misplaced ear tip; misalignment between the ear tip and contact hearing device; and/or displacement of the contact hearing device. Reference signals may be transmitted by the system at preset times or under preset conditions (e.g., when the hearing aid is turned on) or when actuated by the user, a health care provider, or a third party such as the device manufacturer.

In one embodiment of the invention, the invention functions by using a control signal to stimulate the tympanic membrane, generating an acoustic feedback (which may be audible or sub-audible). The hearing aid system detects the feedback signal and analyzes its characteristics, which characteristics may include, for example, amplitude, frequency, phase shift, and/or duration. The characteristics of the feedback signal provide information about the status of elements of the hearing aid system, particularly when those characteristics are compared against similar characteristics of a known system. For example, a benchmark feedback amplitude may be established when a contact hearing system is first installed in a user, with the benchmark feedback amplitude being indicative of a system where all of the elements are properly positioned and working well. The benchmark feedback amplitude may be established by, for example, generating a known reference signal in the ear tip, transmitting that reference signal to the contact hearing device and measuring the feedback signal amplitude to obtain the benchmark feedback amplitude. The system may thereafter generate reference signals at various times to confirm that the feedback amplitude has not changed significantly from the benchmark value. If there is a significant measured difference between the benchmark feedback signal and the measured value, the user and/or healthcare professional may be provided with a notification, allowing the user and/or healthcare professional to check the system components to determine what is causing that variation and make appropriate changes to bring the measured feedback signal back into alignment with the benchmark feedback signal.

In one embodiment, a user goes through a fitting process with an audiologist while the device is being used for the first time and, once an optimal ear tip fitting is achieved, the contact hearing system transmits a control signal, which may be a light signal indicative of a full audio bandwidth signal (e.g., chirp tone) to the contact hearing device and captures the resulting feedback signal with a microphone. The feedback signal information may be stored in a memory of the audio processor and, where available, on an external communication and control device. Once stored the feedback signal information may be used to compare to subsequent measured feedback signals. Examples of the characteristics of the measured feedback signal which may be stored and used as a reference include: impulse response, feedback level, frequency response, phase shift, amplitude changes, transfer functions, and feedback delay.

In embodiments of the invention, once a reference has been established a user may check to see whether the system is working optimally by triggering a feedback measurement wherein the contact hearing system transmits the same reference signal as was transmitted to establish the benchmark feedback signal characteristics and captures the resulting feedback signal using the microphone. The check may be performed when the user has, for example removed and replaced an ear tip, in order to ensure that the ear tip was properly replaced. The resulting feedback information may then be compared with the stored benchmark to ensure that the ear tip is properly placed and working well.

In order to establish the status of the system and its components, the contact hearing system then quantifies the difference between the measured and benchmark feedback signal information and provides that difference information to the user to help a user, for example, find an optimal ear tip position and/or determine whether the contact hearing system has been displaced from its optimal position on the tympanic membrane. The difference information may be provided in real time. The difference information may be provided as a display on an external communication and control device. For example, the contact hearing system may transmit the feedback difference information to an external communication and control device and show the level of difference on screen, e.g., by color, a graph or a bar.

In an embodiment of the invention, the reference signal may be continuously transmitted and the resulting feedback measured as the system is being adjusted with the measured feedback signal providing the user and/or healthcare professional with information to assist the user and/or healthcare professional in properly adjusting the system. In one embodiment, the contact hearing system plays an “optimal fitting sound” if the feedback difference is small enough to ensure a user that ear tip fitting is nearly optimal. With those indicators, a user can interactively find an optimal ear tip position using objective indicators.

In an embodiment of the invention, reference signals may be transmitted periodically and the resulting feedback signal measured. In the event that the measured feedback signal shows a degradation in system performance with respect to a benchmark feedback signal, the system may be adjusted by the user or a health care professional. In the event that the measured feedback signal shows an improvement in system performance, the measured feedback signal is stored as the new benchmark feedback signal. The new benchmark feedback signal may, thereafter be used as the benchmark feedback signal until a new benchmark feedback signal is established. As an example, if the measured feedback amplitude exceeds the reference value by a significant/predetermined value, the measured feedback amplitude may be used as the new benchmark value. In this manner, the system performance may be continually improved.

When feedback profiles are saved on an external communication and control device, the method of the present invention may take advantage of its large memory capacity to store every new feedback measurement and compare it with all the stored profiles to pick the optimal system configuration, such as, for example, the optimal optical coupling location. Over time, the stored feedback profiles may be analyzed to see how the hearing aid performance is degraded due to, for example, wear, and/or fatigue of the ear tip. In embodiments of the invention, feedback profiles may be tagged with time stamps, location tags and counts of the overall number of times the ear tip was inserted and removed.

In other embodiments of the invention, the contact hearing device may be programmed to run the feedback measurement on a regular programmed interval and alert the user if the new measurement deviates in a substantial/predetermined amount from the benchmark, indicating to the user that there has been a change in the system configuration, such as, for example, ear tip migration due to physical activity, indicating to the user that it is time to adjust it to get optimal acoustic performance.

In embodiments of the invention, various techniques and algorithms may be used to differentiate the feedback signal from system noise, the transmitted signal, and ambient noise. For example, in systems where the measured feedback signal is sub-audible it may be possible to use signal extraction techniques to extract the desired feedback signal from the noise. Suitable signal extraction techniques and algorithms include coherent averaging. In a system according to the present invention using coherent averaging, the reference signal may be transmitted repeatedly over a short period of time and the resulting feedback signals detected and stored. The repeated reference signal will ultimately result in a detected feedback signal where the actual feedback signal may be pulled from the noise by coherent averaging.

In embodiments of the invention, the ear tip may be a conventional hearing aid receiver and the measured feedback signal may be a signal generated by the sound reflected off the tympanic membrane of the user or generated by the receiver. In such a system, changes in the feedback signal may be, for example, indicative of wear or degradation in the receiver.

In embodiments of the invention, reference signals may be transmitted each time an ear tip is inserted or removed, to check for errors in the system. Errors may include alignment errors.

In embodiments of the invention, one or more signature reference signals may be transmitted when the system is first set up to establish one or more base line benchmark feedback signals for the preferred system arrangement.

In embodiments of the invention, the feedback signal may be measured and checked for deviations from an optimized response. Such deviations may be indicative of specific changes in the system or components thereof. Such deviations may include phase shifts, frequency shifts, amplitude ratios, and/or amplitude variations. In embodiments of the invention, particular variations may point to particular failure modes and/or suboptimal system setups.

In embodiments of the invention, displacement of the contact hearing device may cause it to move such that the umbo platform is no longer touching the umbo and the characteristics of the hearing aid system are degraded. The degree of movement of the umbo platform from its optimal position on the tympanic membrane will cause a resulting feedback signal to change, which changes may be measured by the present invention. Resulting changes in a measured feedback signal may include changes in the amplitude of the feedback signal with the amplitude of the feedback signal being reduced as the umbo platform is moved farther from its optimal position on the umbo. Displacement of the umbo lens may further result in changes to the frequency response of the tympanic lens, resulting in changes to the frequency and/or phase of a resulting feedback signal.

In embodiments of the invention, the nature and degree of change may be determined by analyzing the characteristics of a feedback signal, including its amplitude, frequency, and phase shift. In embodiments of the invention, the characteristics of the feedback signal may be compared to the characteristics of the reference signal and/or to the characteristics of previously measured feedback signals.

In embodiments of the invention, the reference signal may comprise a frequency sweep and the feedback signal may be examined for changes in the transfer function, such as, for example, where lower frequencies are attenuated less than in the benchmark feedback signal. Such changes in transfer function may be indicative of changes in the system, such as, for example, changes to the alignment of the system components, displacement of the contact hearing device, and/or changes in the cloudiness of the photodetector.

In embodiments of the invention, signatures from specific faults may be used to guide the user to make corrections and adjustments to system components (e.g., repositioning an ear tip) until the measured feedback signal is equal to or approximately equal to the desired (benchmark) feedback signal.

In one embodiment of the invention, a method of establishing and optimizing ear tip to photodetector alignment comprises a series of steps. In one embodiment, these steps take advantage of the nonlinear characteristics of the photodetector being used. In particular, the contact hearing device is positioned on the tympanic membrane and the ear tip is inserted. The laser in the ear tip is then turned on at its maximum power and the feedback signal measured. The power of the laser is then reduced in a step wise fashion until the feedback signal can no longer be detected. The ear tip may then be adjusted until the feedback signal is once again detected, indicating that the alignment has improved. Once the feedback signal is detected the output power of the laser can be reduced again until the feedback signal can no longer be detected and the process repeated until the alignment is fully optimized.

In embodiments of the invention, the reference signal may be a signal which results in a vibration at the tympanic membrane. This vibration may be calibrated to an equivalent pressure output (EPO), where the EPO is the sound pressure required to achieve the same degree of movement of the tympanic membrane as is achieved with the reference signal. The feedback pressure generated by the reference signal (e.g., by vibrating the tympanic membrane using, for example, a microactuator) may then be detected by one or more microphones in the ear canal and/or outside the ear. The calculated EPO may be divided by the measured feedback pressure to generate a ratio. The ratio of calculated EPO to measured feedback may be used to determine whether there are errors or problems in the system. The ratio may be compared against stored ratios to determine whether system characteristics have changed.

In embodiments of the invention, the reference signal may comprise a signal which is adapted to the individual characteristics of the system and/or the user. For example, when a system is first fitted to a user, certain characteristics (such as, for example, Gain Before Feedback and Maximum Equivalent Pressure Output) are conventionally measured and stored. In embodiments of the invention, such characteristics may be used to modify the reference signal to conform the reference signal to an individual user or system. As an example, the measured Gain Before feedback may be used to modify a chirp reference signal by continuously attenuating or amplifying the amplitude of the chirp signal as it is swept across the frequency range according to the measured Gain Before Feedback for the corresponding frequency.

In embodiments of the invention, a method is described for determining the status of at least one elements of a hearing aid system. In embodiments of the invention, the method includes the steps of: generating reference signal, wherein the reference signal mechanically vibrates the tympanic membrane of a user, resulting in the generation of a feedback signal; measuring at least one characteristic of the feedback signal; and comparing the measured characteristic of the feedback signal to a stored value and establishing the status of the at least one element based at least in part on a difference between the measured characteristic and the stored characteristic. In further embodiments of the method, the status of at least one element is a position of an ear tip. In further embodiments of the method, the status of at least one element is an amount of wear of an ear tip. In further embodiments of the method, the status of at least one element is an amount of fatigue of an ear tip. In further embodiments of the method, the status of at least one element is a position of a contact hearing device. In further embodiments of the method, the status of at least one element is a location of an umbo lens. In further embodiments of the method, a user notification is generated when the difference between the measured characteristic and the stored characteristic exceeds a predetermined value. In further embodiments of the method, the user notification is generated audibly through the hearing aid system. In further embodiments of the method, the user notification is generated as a notification to a user's cell phone. In further embodiments of the method, the feedback signal is generated by vibrating the tympanic lens using a device positioned on the tympanic lens.

In embodiments of the invention, a method is described for adjusting the status of at least one element of a hearing aid system, the method including the steps of: generating a reference signal, wherein the reference signal results in the generation of a feedback signal; measuring at least one characteristic of the feedback signal; and adjusting at least one parameter of the hearing aid system such that, when a subsequent reference signal is transmitted, the adjustment modifies the measured feedback signal. In further embodiments of the method, the step of generating a feedback signal includes: transmitting the reference signal to a contact hearing device wherein the movement of at least one element on the contact hearing device in response to the generated reference signal results in the generation of the feedback signal. In further embodiments of the method, the reference signal comprises a light signal. In further embodiments of the method, the reference signal comprises an RF signal. In further embodiments of the method, the reference signal comprises an inductively coupled signal. In further embodiments of the method, the step of generating a feedback signal includes transmitting the reference signal to a tympanic membrane, wherein the movement of the tympanic membrane in response to the generated reference signal results in the generation of the feedback signal. In further embodiments of the method, the reverence signal comprises an acoustic signal.

In embodiments of the invention, a method is described for adjusting at least one element or characteristic of a hearing aid system, the method including the steps of: generating a reference signal, wherein the reference signal causes the generation of a feedback signal, which feedback signal is recorded; repeating the step of generating the reference signal and recording a resulting feedback signal; and using coherent averaging to separate the resulting feedback signal from ambient signals present in the system.

In embodiments of the invention, a method is described for adjusting the alignment of components in a light driven hearing aid comprising an ear tip and a photodetector, the method including the steps of: transmitting a first optical reference signal to the photodetector and measuring any generated feedback; reducing a magnitude of the optical reference signal until a feedback signal is no longer measurable; and adjusting one or more components of the light driven hearing aid until a feedback signal is measurable in response to a generated reference signal. In further embodiments of the method, the method further includes the steps of: decreasing the magnitude of the optical reference signal until a feedback signal is no longer measurable; and adjusting one or more components of the light driven hearing aid until a feedback signal is measurable in response to a generated reference signal. In further embodiments of the method, the one or more components of the light driven hearing aid comprises the ear tip.

In embodiments of the invention, a method is described for detecting the displacement of a contact hearing device, the method including the steps of: establishing a baseline feedback signal with the contact hearing device positioned correctly; transmitting a reference signal one or more times after establishing the baseline feedback signal and measuring the resulting feedback signal; comparing the resulting feedback signal to the baseline feedback signal and providing the user with an error indication when one or more characteristics of the measured feedback signal differs from the baseline feedback signal. In further embodiments of the method, the one or more characteristics comprise the amplitude of the feedback signal. In further embodiments of the method, the reference signal comprises a chirp signal. In further embodiments of the method, the reference signal comprises a broad band noise signal. In further embodiments of the method, the reference signal comprises a sweep signal.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

### REFERENCE NUMBERS

| Number | Element |
|---|---|
| 110 | Contact Hearing System |
| 111 | Acoustic Hearing System |
| 112 | Contact Hearing Device |
| 120 | Ear Tip |
| 121 | Receiver |
| 130 | Photodetector |
| 132 | Audio Processor |
| 134 | Audio Processor Antenna |
| 140 | Microactuator |
| 141 | Support Structure |
| 142 | Light Pulses |
| 143 | Acoustic Signal |
| 144 | Springs |
| 220 | Umbo Lens |
| 250 | Taper Tube |
| 260 | Cable |
| 290 | Light Source |
| 291 | Speaker |
| 310 | External Microphone |
| 312 | Canal Microphone |
| 320 | Analog to Digital Converter |
| 324 | External Communication and Control Device |
| 330 | Digital Signal Processor |
| 338 | Acoustic Vent |
| 340 | Acoustic Input (Audible Sound) |
| 342 | Acoustic Feedback |
| TM | Tympanic Membrane |

1. A method of determining the status of at least one elements of a hearing aid system, the method comprising the steps of:
generating reference signal, wherein the reference signal mechanically vibrates the tympanic membrane of a user, resulting in the generation of a feedback signal;
measuring at least one characteristic of the feedback signal; and
comparing the measured characteristic of the feedback signal to a stored value and establishing the status of the at least one element based at least in part on a difference between the measured characteristic and the stored characteristic.

2. A method according to claim 1 wherein the status of at least one element is a position of an ear tip.

3. A method according to claim 1 wherein the status of at least one element is an amount of wear of an ear tip.

4. A method according to claim 1 wherein the status of at least one element is an amount of fatigue of an ear tip.

5. A method according to claim 1 wherein the status of at least one element is a position of a contact hearing device.

6. A method according to claim 5 wherein the status of at least one element is a location of an umbo lens.

7. A method according to claim 1 wherein a user notification is generated when the difference between the measured characteristic and the stored characteristic exceeds a predetermined value.

8. A method according to claim 7 wherein the user notification is generated audibly through the hearing aid system.

9. A method according to claim 7 wherein the user notification is generated as a notification to a user's cell phone.

10. A method according to claim 1 wherein the feedback signal is generated by vibrating the tympanic lens using a device positioned on the tympanic lens.

11. A method of adjusting the status of at least one element of a hearing aid system, the method comprising the steps of:
generating a reference signal, wherein the reference signal results in the generation of a feedback signal;
measuring at least one characteristic of the feedback signal; and
adjusting at least one parameter of the hearing aid system such that, when a subsequent reference signal is transmitted, the adjustment modifies the measured feedback signal.

12. A method according to claim 11 wherein the step of generating a feedback signal comprises:
transmitting the reference signal to a contact hearing device wherein the movement of at least one element on the contact hearing device in response to the generated reference signal results in the generation of the feedback signal.

13. A method according to claim 12 wherein the reference signal comprises a light signal.

14. A method according to claim 12 wherein the reference signal comprises an RF signal.

15. A method according to claim 12 wherein the reference signal comprises an inductively coupled signal.

16. A method according to claim 11, wherein the step of generating a feedback signal comprises:
transmitting the reference signal to a tympanic membrane, wherein the movement of the tympanic membrane in response to the generated reference signal results in the generation of the feedback signal.

17. A method according to claim 11 wherein the reverence signal comprises an acoustic signal.

18. A method of adjusting at least one element or characteristic of a hearing aid system, the method comprising the steps of:
generating a reference signal, wherein the reference signal causes the generation of a feedback signal, which feedback signal is recorded;
repeating the step of generating the reference signal and recording a resulting feedback signal; and
using coherent averaging to separate the resulting feedback signal from ambient signals present in the system.

19. A method of adjusting the alignment of components in a light driven hearing aid comprising an ear tip and a photodetector, the method comprising the steps of:
transmitting a first optical reference signal to the photodetector and measuring any generated feedback;
reducing a magnitude of the optical reference signal until a feedback signal is no longer measurable; and
adjusting one or more components of the light driven hearing aid until a feedback signal is measurable in response to a generated reference signal.

20. A method according to claim 19, wherein the method further comprises the steps of:
decreasing the magnitude of the optical reference signal until a feedback signal is no longer measurable; and
adjusting one or more components of the light driven hearing aid until a feedback signal is measurable in response to a generated reference signal.

21. A method according to claim 20, wherein the one or more components of the light driven hearing aid comprises the ear tip.

22. A method of detecting the displacement of a contact hearing device, the method comprising the steps of:
establishing a baseline feedback signal with the contact hearing device positioned correctly;
transmitting a reference signal one or more times after establishing the baseline feedback signal and measuring the resulting feedback signal;
comparing the resulting feedback signal to the baseline feedback signal and providing the user with an error indication when one or more characteristics of the measured feedback signal differs from the baseline feedback signal.

23. A method according to claim 22, wherein the one or more characteristics comprises the amplitude of the feedback signal.

24. A method according to claim 22 wherein the one or more characteristics comprises the frequency of the feedback signal.

25. A method according to claim 22 wherein the reference signal comprises a chirp signal.

26. A method according to claim 22 wherein the reference signal comprises a broad band noise signal.

27. A method according to claim 22 wherein the reference signal comprises a sweep signal.
